(19) United States
(12) Patent Application Publication
(10) Pub. No.: US 2007/0148339 A1
(43) Pub. Date: Jun. 28, 2007

(54) Water-resistant vegetable protein powder adhesive compositions

(76) Inventors: James M. Wescott, Waunakee, WI (US); Michael Birkeland, Edgerton, WI (US); Charles R. Frihart, Dane, WI (US)

Correspondence Address: QUARLES & BRADY LLP, 411 E. WISCONSIN AVENUE, SUITE 2040, MILWAUKEE, WI, 53202-4497, US

(21) Appl. No.: 11/607,204

(22) Filed: Dec. 1, 2006

Related U.S. Application Data
(60) Provisional application No. 60/741,507, filed on Dec. 1, 2005.

(51) Int. Cl. C08L 5/08; C09J 103/00; C09J 189/00; C08L 89/00; C08L 91/00; C09D 189/00

(52) U.S. Cl. 427/180; 106/162.2; 106/131.1; 106/124.1; 106/132.1; 106/132.2; 106/125.1; 106/148.1; 106/148.4; 106/148.5; 106/148.51; 106/148.52; 106/155.1; 106/155.2; 106/155.21; 106/156.2; 106/156.21; 106/156.22; 106/156.25; 106/156.3; 106/156.31; 106/156.5

(57) ABSTRACT

Water-resistant, protein-based powder adhesive compositions and methods for preparing them are provided. The adhesives are prepared by denaturing a vegetable protein, such as soy flour to the “preferred adhesive state”, co-polymerizing with one or more reactive cross-linking agents and spray-drying or freeze-drying the composition to preserve the preferred adhesive state. The adhesives exhibit superior water resistance, and can be used to bond wood substrates, such as panels or laminate, or in the preparation of composite materials.

### CROSS-REFERENCE TO RELATED APPLICATIONS

This application claims priority to provisional application No. 60/741,507, filed Dec. 1, 2005, which is hereby incorporated by reference herein.

### STATEMENT REGARDING FEDERALLY SPONSORED RESEARCH OR DEVELOPMENT

Not Applicable.

### BACKGROUND OF THE INVENTION

Ancient adhesives raw material choices were limited. Starch, blood, and collagen extracts from animal bones and hides were early adhesives sources. Later, suitable raw materials used in adhesives expanded to include milk protein and fish extracts. These early starch and protein-based adhesives suffered from a number of drawbacks, including lack of durability and poor water resistance.

Adhesives based on protein-containing soy flour first came into general use during World War I. To obtain suitable soy flour for use in these early adhesives, some or most of the oil was removed from soybean, yielding a residual soy meal that was subsequently ground into extremely fine soy flour. The resulting soy flour was then denatured and, to some extent, hydrolyzed to yield adhesives for wood bonding under dry conditions. However, these early soybean adhesives suffered from the same drawbacks as other early protein-based adhesives, namely poor water resistance, and their use was strictly limited to interior applications. Another of the drawbacks was the limited pot life of the denatured soy flour alkaline mixture. After only a few hours, the viscosity and, ultimately the performance, of the denatured soy flour alkaline mixture would rapidly decrease (see FIG. 1). This reduction is believed to be a result of hydrolysis of the soy flour or perhaps excessive disruption of the higher order structure. The area marked as the “preferred adhesive state” is the target area for the denatured soy adhesives in this patent. The actual period of time that the adhesive exists in the “preferred adhesive state” is a function of temperature, pH, and denaturant concentration and type. Under extreme conditions (high pH, high temperature, strong denaturant) the period can be as low as a matter of minutes.

In the 1920's, phenol-formaldehyde (PF) and urea-formaldehyde (UF) adhesive resins were first developed. Phenol-formaldehyde and, less frequently, modified urea-formaldehyde resins were exterior-durable, but high raw materials costs at that time limited their use. World War II contributed to the rapid development of these adhesives for water and weather resistant applications, including exterior applications. However, the low cost protein-based adhesives, mainly soy-based adhesives, continued to be used in many interior applications.

After World War II, the petrochemical industry invested vast sums of money in research and development to create and expand new markets for petrochemicals. Within several years, the once costly raw materials used in manufacturing thermoset adhesives became inexpensive bulk commodity chemicals. In the 1960's, the price of petrochemical-based adhesives had dropped substantially, such that they displaced nearly all of the protein-based adhesives from the market.

Powder adhesives are often the preferred adhesive in the structural wood composite market, as well as for molded products, for a variety of reasons. Advantages over liquid adhesives include lower press temperatures, shorter press times, longer stabilities, lower resin loading, and lower transportation cost, plus better control over total moisture in the composite panel. The use in molded products is more of a requirement than a preference, since the closed mold is not amenable to aqueous based adhesives, due to the molds limited ability for water removal.

### SUMMARY OF THE INVENTION

When soy flour is denatured in an aqueous media, the adhesive ability of the material is much improved. This initially denatured product is well-accepted to be the preferred adhesive state. By “preferred adhesive state” we mean the denatured material has at least 50%, preferably 75% and most preferably 85%, of peak viscosity and dry adhesive and cohesive strengths.

However, within a matter of minutes to hours, the soy flour undergoes a variety of destructive/hydrolyzing reactions that diminish its performance as an adhesive. This is a combination of chain scission and disruption of the essential higher order structure. A soy adhesive of the present invention can be prepared wherein the aqueous soy mixture is converted into a powder adhesive prior to the onset of significant hydrolysis/destructive reactions, thus allowing the soy adhesive to be stored in the preferred adhesive state for an unlimited period of time. (By “significant hydrolysis/destructive reactions” we mean the viscosity and performance of the denatured material will drop by less than 50%, preferably less than 25% and most preferably less than 15%.) Moreover, in one embodiment the denatured soy mixture may be combined with a variety of cross-linking agents in a one-pot process prior to drying to produce a stable, powder adhesive with an extensive room temperature shelf life.

The process of the present invention is preferably a one-pot process where the protein can be denatured at any time prior to drying. This denaturation can even be accomplished in the presence of the cross-linking agent as long as a suitable denaturant is present. In one embodiment, the denaturation is in the presence of a viable cross-linking agent. In another embodiment, the cross-linker may be added after the denaturation

Past attempts to combine soy protein with cross-linking resins, such as phenol-formaldehyde, have generally been unsatisfactory in producing a suitable adhesive that can compete with the standard thermoset resin in all aspects. For example, some resins are only suitable for use in two-component systems that cure too quickly for use in making composites and may even offer pot lives too short to allow for spray drying. (See Kriebich-2^{nd} Biennial Wood Residues Into Revenue, Residual Wood Conference Proceedings, November 1997; Li US 2004/0089418 A1.)

Other resins require high caustic levels and/or temperatures that will lead to over hydrolysis and, thus, the soy no longer exists in the preferred adhesive state, leading to inferior performance. (See Trocino-WO-01/59026; Vijayendran US 2002/0153112 A1; Chung-Yun Hse, et al., Wood Adhesives, 2000). Kuo (U.S. Pat. No. 6,306,997 B1) developed a soy-PF resin where the pH is maintained at low levels (6.8-7.1); this can prevent proper denaturing (not allowing the soy to reach the preferred adhesive state) as well as slow curing of the cross-linking agent. Further, Kuo states that “soybean flour is not compatible with alkaline PF resins” within the technology of that patent.

Over the past several years, the cost of petrochemicals used as raw materials in thermoset resins has risen to the point where protein-based adhesives can now compete economically in the same markets that are today enjoyed by the thermoset adhesives. A protein-based adhesive that combines the cost benefits of a low cost raw material with the superior exterior durability characteristics of thermoset adhesives is therefore highly desirable.

Therefore, a low cost soybean-based powder adhesive suitable for exterior use is provided. The adhesive can be prepared using a simple one-pot process followed by a drying process. On a laboratory scale, it was found that freeze-drying is the most efficient means of drying the material, while commercially it is expected that conventional spraying techniques could be employed.

The process of the present invention involves three steps:

I) Protein Denaturation

II) Blending/pre-reaction with protein cross-linking agents (optional)

III) Conversion to powder

The denaturation of the soy flour is typically carried out under alkaline conditions using a 50% sodium hydroxide solution.

Suitable cross-linking agents include any material capable of reacting with protein to result in a thermoset resin. Possible cross-linking agents are both formaldehyde containing, such as phenol-formaldehyde, urea-formaldehyde, or melamine-formaldehyde resin, or formaldehyde free, such as isocyanates, epoxides, sulfides, polyamidoamine epichlorohydrins (PAEs), glyoxal or any other material capable of cross-linking denatured soy flour. In one embodiment of the invention, we would use the following materials as additives and cross-linkers: linseed oil, tung oil, maleic anhydride (or simply maleinized oils) modified oils or derivation of the materials. The stage I protein denaturation may occur prior to or at the same time as the stage II blending.

Accordingly, a method of preparing a protein-based adhesive is provided. The method includes denaturing a protein, whereby a denatured protein in a preferred adhesive state is obtained; and drying the protein, wherein the protein is in a powder form. The method also comprises blending/pre-reacting the denatured protein with a cross-linking agent, preferably under basic conditions, to yield a co-polymerized product.

The cross-linking agent is selected from the group consisting of phenol-formaldehyde, urea-formaldehyde, melamine-formaldehyde, melamine-urea-formaldehyde, isocyanates, epoxides, modified poly(vinyl acetates), sulfides, polyamidoamine epichlorohydrins (PAEs), glyoxal or any other material capable of cross-linking denatured soy flour and mixtures thereof and drying the aqueous mixture by a number of methods including spray drying or freeze drying.

The protein includes a soy protein, such as a soy flour, or a soy isolate. The soy flour has a particle size of about 80 mesh or less and includes from about 0 wt. % to about 12 wt. % of soy bean oil, and about 30 wt. % to about 100 wt. % of a protein.

Denaturing is conducted in the presence of an alkali such as sodium hydroxide or potassium hydroxide. Denaturing includes the steps of forming an aqueous, alkaline mixture of the protein; whereby a denatured protein is obtained. The mixture can include from about 6 wt. % to about 20 wt. % sodium hydroxide. Denaturing is conducted for about 0-20 hours or more and at a temperature of from 10° C. to 60° C.

Cross-linking the denatured protein with a cross-linking agent is conducted at temperatures from 10° C. to 90° C. Additional cross-linking agents may also be combined with the denatured protein.

The adhesive includes from about 0 wt. % to about 99 wt. % of the cross-linking agent, and contains a solids content of from 80 wt. % to 100 wt. %. The adhesive has a pH of from 1 to 13.5.

The method further includes the step of adding a component selected from the group consisting of extenders, fillers, accelerators, flow modifiers, plasticizers, catalysts, water, and mixtures thereof to the adhesive.

In an alternative embodiment, the method includes the step of providing a solid substance; contacting the solid substance with the dried adhesive; and recovering a composite. The solid substance may include an agricultural material such as corn stalk fiber, poplar fiber, wood chips, and straw. The composite may include a fiberboard.

The composite board may further include a solid material selected from the group consisting of wood chips, wood fiber, wood flour, wood flakes, wood board, wood veneer, wood particles, corn stalk fiber, poplar fiber and straw.

In a final embodiment, the composite board further includes a wax.

### BRIEF DESCRIPTION OF THE FIGURES

FIG. 1 shows Identification of the “preferred adhesive state;”

FIG. 2 shows soy flour solubility in water as a function of pH; and

FIG. 3 shows retention of “preferred adhesive state” via freeze-drying.

### DETAILED DESCRIPTION OF THE PREFERRED EMBODIMENT

In General

In one embodiment of the present invention, water-resistant, protein-based powder adhesive compositions and methods for preparing the compositions are provided. The adhesives are prepared by denaturing a vegetable protein, such as soy flour, to the preferred adhesive state and then co-polymerizing this material with one or more reactive cross-linking agents. The aqueous resin mixture is subsequently spray-dried or freeze-dried to afford a stable powder adhesive. The adhesives exhibit superior water resistance and can be used to bond wood substrates, such as panels, molded products, laminates, or in the preparation of composite materials.

The following description and examples illustrate a preferred embodiment of the present invention in detail. Those of skill in the art will recognize that there are numerous variations and modifications of this invention that are encompassed by its scope. Accordingly, the description of a preferred embodiment should not be deemed to limit the scope of the present invention.

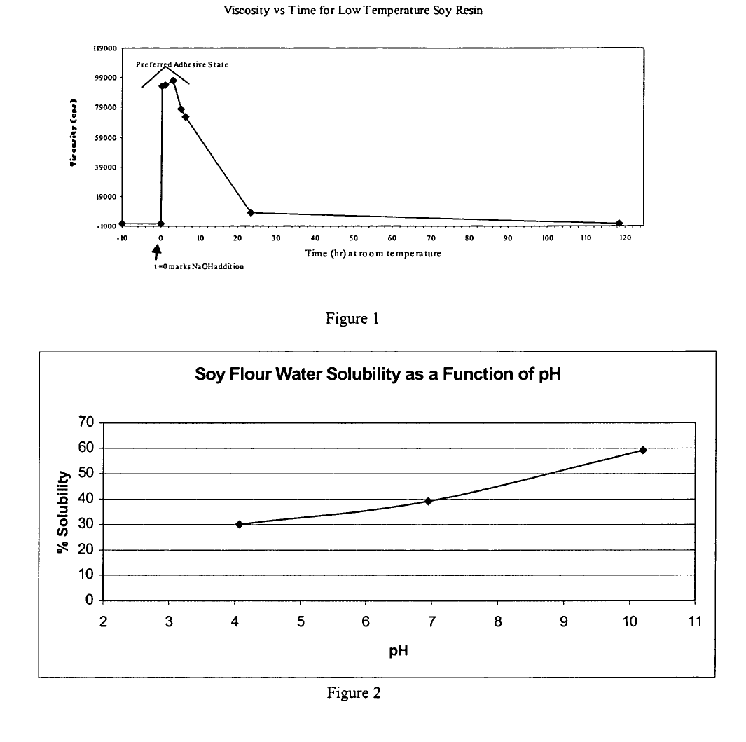

Soy flour can be easily dispersed into water. The solubility of the flour depends upon the exact conditions employed and the state of the soy flour. Higher pH conditions will allow for greater solubility, while lower pH conditions will offer lower solubility, particularly, as the pH approaches 4.5 which is the isoelectric point of many of the proteins contained in soy flour. See FIG. 2 for details.

The processes of preferred embodiments involve the denaturation of proteins for use in adhesive formulations. The denatured proteins can be blended with one or more reactive cross-linking agents prior to drying. The selection of the protein source, its denaturation conditions, the selection of the cross-linking agent, and the drying process can each contribute to the adhesive's performance.

The process for preparing durable vegetable protein-based adhesives from soy flour involves preparing the flour, denaturing the flour, blending/pre-reacting the denatured soy protein with a suitable cross-linking agent, such as formaldehyde-modified phenol and then drying the aqueous mixture rapidly via freeze drying or spray drying methodologies. Other suitable cross-linking agents include, urea formaldehyde, isocyanates, modified poly(vinyl acetates), epoxides, sulfides, polyamidoamine epichlorihydins (PAEs), glyoxal and any other product capable of reacting with denatured soy protein. Of interest, the denaturing step may be conducted in the presence of the cross-inking agent.

The Protein Source

The process employs a suitable protein source for the cross-linking to form adhesive bonds. Protein sources having high protein contents, such as 40 wt. % or less up to about 100 wt. %, are generally preferred. Particularly preferred are protein contents of from about 45 wt. % to about 50, 55, 60, 65, 70, 75, 80, 85, 90, 95, or 100 wt. %. Higher protein content generally correlates with improved co-polymerization, resulting in the formation of strong adhesive bonds and better water resistance. While enriched protein sources are generally preferred, non-enriched protein sources can also be employed. Accordingly, many biomass materials with appreciable protein content are suitable for use in the preferred embodiments.

While the preferred embodiments refer to soybean flour as the protein source, other protein sources are also suitable for use, as will be appreciated by those of skill in the art. Soybean flour is generally preferred due its low cost and good protein content. Non-limiting examples of other sources of vegetable protein include, for example, nuts, seeds, grains, and legumes. These sources include, but are not limited to, peanuts, almonds, brazil nuts, cashews, walnuts, pecans, hazel nuts, macadamia nuts, sunflower seeds, pumpkin seeds, corn, peas, wheat, and the like. Other sources include protein-containing biomasses, such as waste sludge, manure, and composted manure. Additional and/or different processing steps from those described for preparing soy meal can be used in refining and separating a protein from a raw product of other protein sources, as will be appreciated by one skilled in the art. The processed proteins can be employed to produce adhesives acceptable for various applications.

Soy protein isolates are a highly digestible source of amino acids: the protein building blocks essential for human health. Soy protein isolates contain about 90% protein, and are low in fat, calories and cholesterol. They are the most highly refined soy protein products available to consumers. Food manufacturers use soy protein isolates in infant formula, nutritional supplements, meat and dairy products, and meat analogs. They are used in applications requiring emulsification/emulsion stabilization, water and fat absorption and adhesive/fiber-forming properties. Soy protein isolates do not alter the flavor of foods.

Soy flour comprises a hull (8 wt. %), a hypocotyl axis (2 wt. %) and a cotyledon (90 wt. %). The soybean plant belongs to the legume family. There are typically 2-3 seeds per pod and as many as 400 pods per plant. The soy flour is prepared by grinding soy meal. There are several suitable processes for the generation of soy meal. Soy meal is obtained from soybeans by separating all or a portion of the oil from the soybean, for example, by solvent extraction, extrusion, and expelling/expansion methods.

To produce a soy meal suitable for use in the adhesives of the preferred embodiments, it is preferably ground into fine flour. Typically, the dry extracted meal is ground so that nearly all of the flour passes through an 80 or finer mesh screen. In certain embodiments, flour milled to pass through higher or lower mesh screen can be preferred, for example, about 20 mesh or less down to about 200 mesh or more, more preferably from about 25, 30, 35, 40, 45, 50, 55, 60, 65, 70, or 75 mesh to about 80, 85, 90, 95, 100, 110, 120, 130, or 140 mesh. In the preferred embodiments, the soy meal contains about 40 wt. % or more protein. However, soy meals with lower protein content can also be suitable in certain embodiments. Soy meals having various oil contents can be employed in the preferred embodiments.

Denaturation of the Protein

The soy protein in soybeans is primarily a globular protein consisting of a polypeptide chain made up of amino acids as monomeric units. Proteins typically contain 50 to 2000 amino acid residues per polypeptide chain. The amino acids are joined by peptide bonds between the alpha-carboxyl groups and the alpha-amino groups of adjacent amino acids, with the alpha-amino group of the first amino acid residue and the alpha-carboxyl group of the last amino acid residue of the polypeptide chain being free. The molecular structures of soy proteins contain a hydrophilic region on the interior of the globular structure and a hydrophobic region on the exterior, such that many of the polar groups are unavailable for bonding to a substrate. It is the same forces that maintain the globular folded structure of the protein that are desirable for bonding.

The globular shape of proteins in aqueous solution is a consequence of the fact that the proteins expose as small a surface as possible to the aqueous solvent so as to minimize unfavorable non-polar interactions with the water and to maximize favorable interactions of the amino acid residues with each other. The conformation of the protein is maintained by disulfide bonds and by non-covalent forces, such as van der Waals interactions, hydrogen bonds, and electrostatic interactions.

When a protein is treated with a denaturant, some of the native globular conformation is lost because the denaturant interferes with the forces maintaining the configuration. The result is that more polar groups of the protein are available for reaction in adhesion and that more side groups are available for cross-linking.

In preparing the adhesives of the preferred embodiments, the protein is first denatured. The polar groups are uncoiled and exposed to facilitate the development of a good adhesive bond and cross-linking. However, extensive periods of time in an aqueous solution will result in the development of significant destructive/hydrolysis reactions that will reduce the performance of the protein-based adhesive, most notably at higher pHs. Once this occurs, the adhesive is no longer in the preferred adhesive state. As described above, by “preferred adhesive state” we mean the protein is denatured and at a viscosity of at least 50% of maximum, preferably greater than 75% and most preferably greater than 85%. Drying the adhesive, by either freeze drying or spray drying techniques allows for the soy to be maintained in the preferred adhesive state for an unlimited period of time.

The denaturant can include any material capable of disrupting the intramolecular forces within the protein structure by breaking hydrogen bonds and/or cleaving disulfide bonds. Reagents that can be employed to cleave disulfide bonds include oxidizing agents, such as sodium bisulfite, and other substances as are known in the art. Suitable denaturants include, but are not limited to, organic solvents, detergents, acids, bases, or heat.

Particularly preferred denaturants include sodium hydroxide, potassium hydroxide, other alkali and alkaline metal hydroxides, concentrated urea solutions, and mineral acids. In the preferred embodiments, the alkali or acid treatments are conducted at room temperatures. Preferably, metal hydroxides, such as sodium hydroxide, are employed due to their ability to elevate the pH to the desired level and increase the solubility and cross-linking efficiency of the adhesive. A suitable pH contributes to proper solubility of the soy flour or other protein, as well as to catalyze the cross-linking reaction with the cross-linking agent, such as phenol formaldehyde or others.

Excess denaturant is generally not preferred, although in certain embodiments it can be acceptable or even desirable to employ excess denaturant. Most preferably, the denaturant is sodium hydroxide, which is preferably employed at an amount of from about 5 wt. % or less to about 40 wt. % or more, based on sodium hydroxide to protein, preferably from about 6, 7, 8, or 9 wt. % to about 30 or 35 wt. %, and most preferably from about 10, 11, 12, 13, 14, or 15 wt. % to about 16, 17, 18, 19, 20, 21, 22, 23, 24, or 25 wt. %. The amount of sodium hydroxide employed is preferably kept as low as possible, and the amount employed is preferably directly related to the amount of protein present in the flour. For a typical soy flour containing from about 40 wt. % to about 50 wt. % protein, the amount of sodium hydroxide is preferably from about 8 wt. % to about 12 wt. %. If the amount of sodium hydroxide is insufficient, inadequate denaturation and cross-linking can result, which in turn can result in inferior performance. It is possible to employ the caustic that is already present in a suitable cross-linker, like phenol-formaldehyde, as the denaturant. This allows for the soy flour to be added directly to the cross-linking agent and for the denaturation reaction to occur in the presence of the cross-linker.

To aid in the solubility, compatibility, stability and flow behavior of the final powdered adhesive, antioxidants, accelerators and compatibilizing or plasticizing materials can be added. In one embodiment of the invention, we would use the following materials as additives and cross-linkers: linseed oil, tung oil, maleic anhydride modified oils or derivation of the materials. The stage I protein denaturation may occur prior to or at the same time as the stage II blending. These include, but are not limited to, ethylene glycol, poly(ethylene glycol), glycerol, and other ionic and non-ionic surfactants as are known in the art.

Denaturation can occur over a wide temperature range. The denaturation reaction can be carried out at temperatures from about 10° C. or lower to about 90° C. or higher, preferably from about 10° C. to 20° C. to about 60° C. to 70° C., and most preferably from about 25° C., 30° C., or 45° C. to about 50° C.

The denaturation time is dependent on the amount of denaturant employed, the particle size of the soy flour or other protein source, and the reaction temperature. Preferably, the denaturation time is from about 1 minute or less to about 100 hours or more, preferably from about 2, 3, 4, or 5 minutes to about 3, 4, 5, 6, 7, 8, 9, 10, 11, 12, 18, 24, 30, 36, 42, 48, 54, 60, 66, or 72 hours, and most preferably from about 10, 15, 20, 25, or 30 minutes to about 40, 50, 60, 70 80, 90, 100, 110, or 120 minutes. Excessive temperatures, reaction times, and/or denaturant levels can lead to unacceptably high levels of hydrolysis, which in turn results in high water extractibles and poor water resistance of the cured adhesive. However, in certain embodiments, temperatures, reaction times, and/or denaturant levels outside of the preferred ranges can be tolerated, or even desired. Maintaining the proper balance of denaturant, temperature, and time of reaction yields a satisfactory denatured soy protein that can be employed in the preparation of durable cross-linked powder adhesives.

Soy flour tends to foam during heating in water. Accordingly, it can be desirable to employ a suitable antifoam agent to the denaturing step. It is preferred that the level of antifoam does not exceed 2% of the total soy. Preferably, from about 0.01 g or less to about 0.2 g or more of antifoam agent is employed per 150 g flour, more preferably from about 0.02, 0.03, 0.04, 0.05, 0.06, 0.07, or 0.08 g to about 0.09, 0.10, 0.11, 0.12, 0.13, 0.14, 0.15, 0.16, 0.17, 0.18, or 0.19 g antifoam agent per 150 g flour. Suitable antifoams include siloxanes, fatty acids, fatty acid salts, and other materials capable of reducing the surface tension of the soy flour in solution.

Blending/Pre-Reactions with Cross-Linking Agents

Cross-linking agents can be formed in situ with the denatured protein, or can be formed separately and mixed with the denatured protein. (Due to the low amount of hydrolysis of the soy protein in this process, the level of free formaldehyde in any potential cross-linking agent must be very low or gelation will occur during mixing with the soy and prior to drying. Suitable chemistries include phenol, melamine, urea, and combinations thereof reacting with formaldehyde or a formaldehyde generator. The process for making such resins is a two-step process involving methylolation followed by condensation. These same two steps can be employed in conjunction with the soy flour based resin systems of preferred embodiments, along with an additional denaturation step.

In one aspect of the invention, the adhesive has a pH of from 1 to 13.5. In an alternative aspect of the first embodiment, the adhesive has a pH of 9 to 13.5. In a second alternative aspect of the invention, the pH is between 2-5.

The pH of the final aqueous adhesive resin prior to drying for optimal durability is generally from about 9 or less to about 13.5 or more, preferably from 9.1, 9.2, 9.3, 9.4, 9.5, 9.6, 9.7, 9.8, or 9.9 to about 13.6, 13.7, 13.8, or 13.9, most preferably from about 11, 11.1, 11.2, 11.3, 11.4, 11.5, 11.6, 11.7, 11.8, or 11.9 to about 13, 13.1, 13.2, 13.3, 13.4, or 13.5. If the pH of the adhesive is less than 9, additional base, such as sodium hydroxide, can be added to decrease the viscosity version of the adhesive. If the final adhesive has a pH over 13.5, the resin may not properly cure, leading to poor performing resins. In certain embodiments, a pH of less than 9 or greater than 13.5 can be tolerated, or is even desirable; most likely depending on the cross-linking agent selection.

The amount of cross-linking agent added can be from 0 wt. % or less to 99 wt. % or more. For applications where durability is of less importance, an amount of from about 21, 22, 23, 24, 25, 26, 27, 28, or 29 wt. % to about 41, 42, 43, 44, 45, 46, 47, 48, 49, or 50 can be employed, preferably from about 30, 31, 32, 33, 34, or 35 to about 36, 37, 38, 39, or 40 wt. %. For applications where high durability is desired, from about 50, 51, 52, 53, 54, 55, 56, 57, 58, or 59 wt. % to about 71, 72, 73, 74, 75, 76, 77, 78, 79, or 80 wt. % can be employed, preferably from about 60, 61, 62, 63, 64, or 65 wt. % to about 66, 67, 68, 69, or 70 wt. %. A mixture of cross-linking agents can also be employed.

The rate of copolymerization can be increased by the addition of cure accelerators or catalysts. Typical cure accelerators include propylene carbonate, ethyl formate, and other alpha esters for phenolic resins. Catalysts, such as sodium or potassium carbonate, can also be added to increase the rate of reaction and also the resin solids content. Other catalysts recognized to accelerate the cross-linking reactions can be employed as needed.

Additives

Many additives can be employed in the preparation of adhesive resins. These additives can lower viscosity, increase cure speed, assist resin flow and distribution, extend shelf life, or lower the cost of the resin. Such additives include, but are not limited to poly(ethylene glycol) [PEG], glycerol, ethylene glycol, propylene carbonate, ethyl formate, urea, sodium carbonate, and sodium bicarbonate. Any suitable additive can be employed, provided that the water resistance of the resin is acceptable. A water extraction of the resin of less than about 35% is generally preferred. However, in certain embodiments a higher water extraction can be acceptable. Due to the foaming nature of soy flour upon heating in a water solution, an antifoam agent can be advantageously employed, preferably at a concentration of less than 2% of the total soy flour in the formula. It is generally preferred to employ as little antifoam agent as possible.

Drying the Adhesive

The adhesive of the present invention would be converted to a powder form by various techniques to remove water. Preferably, one would spray or freeze. The Examples below demonstrate one preferred method of freeze-drying. The process of spray-drying the aqueous resin solution to form a powdered resin is expected to be the most economical method of large-scale conversion of these aqueous resins to powder products. Any commercial spray-drier should be applicable to this technology. NIRO (Copenhagen, Denmark) is one example of a commercial spray-drier manufacturer. The process is not limited by any particular inlet temperature, feed rate, spray flow or resin solids.

Use of Adhesives in Composition Boards

The adhesives of preferred embodiments are suitable for use in a variety of applications, including, but not limited to, applications in which conventional resin adhesives are typically used. One particularly preferred application for the adhesives of the preferred embodiments is in the manufacture of composition boards. Oriented strand boards (face and core sections), plywood, particleboard, laminated veneer lumber, molded products, and fiberboards are a few examples of possible applications of the resin systems of preferred embodiments. Composition boards can be fabricated from any suitable wood or agricultural material, such as wood, straw (wheat, rice, oat, barley, rye, flax, grass), stalks (corn, sorghum, cotton), sugar cane, bagasse, reeds, bamboo, cotton staple, core (jute, kenaf, hemp), papyrus, bast (jute, kenaf, hemp), cotton linters, esparto grass, leaf (sisal, abaca, henequen), sabai grass, small diameter trees, stand improvement tree species, mixed tree species, plantation residues and thinnings, point source agricultural residues, and recycling products such as paper and paper-based products and waste, and the like. Composition boards prepared using the adhesives of the preferred embodiments possess acceptable physical properties as set forth in industry standards and offer the possibility of lower cost and/or lower volatility products.

Phenol is regulated under the Resource Conservation and Recovery Act, and is listed by the U.S. Environmental Protection Agency (EPA) as a water priority pollutant, a volatile organic compound, and an air toxic listed on the hazardous air pollutant list. Very high concentrations of phenol can cause death if ingested, inhaled or absorbed through skin, and exposure to lower concentrations can result in a variety of harmful health effects. Formaldehyde exposure is also regulated by various governmental agencies, including the U.S. Occupational Safety and Health Administration. If formaldehyde is present in the air at levels at or above 0.1 ppm, acute health effects can occur. Sensitive people can experience symptoms at levels below 0.1 ppm, and persons have been known to develop allergic reactions to formaldehyde through skin contact. Formaldehyde has caused cancer in laboratory animals and may cause cancer in humans.

Because of the adverse health effects associated with exposure to phenol and formaldehyde, adhesives prepared using phenol and formaldehyde as starting materials that have a low level of free phenol and free formaldehyde in the finished adhesive are desirable. Especially desirable are adhesives that comply with EPA regulations for low Volatile Organic Compound (VOC) products. Preferably, the adhesives of preferred embodiments contain less than about 2.5 wt. % free phenol. More preferably, the adhesives contain less than about 2.25, 2, 1.75, 1.5, 1.25, 1, 0.75, 0.5, 0.25, 0.1, 0.05, 0.01, 0.005 or 0.001 wt. % free phenol. Preferably, the adhesives of preferred embodiments contain less than about 1% free formaldehyde. More preferably, the adhesives contain less than about 0.75, 0.5, 0.25, 0.1, 0.075, 0.05, 0.025, 0.01, 0.0075, 0.005, 0.0025, or 0.001 wt. % free formaldehyde.

The powdered product may be applied in a number of different ways. The powder may be applied to a substrate, whereupon heat would be applied to the powder/composite product to introduce flow to the powder, which is the preferred method of generating a good adhesive bond between the substrate and the adhesive. Additionally, the powder resin may be reconstituted into water, or into any other viable solvent, and applied to a substrate, preferably by spraying or rolling. It is also possible to apply the powder resin while in the solid state to the substrate and then to introduce water as to allow the powder to flow without the addition of heat. Steam injection pressing techniques are an example of the latter process.

### EXAMPLES

### Example 1

A powder soy resin was prepared by combining components in the order as listed in Table 1. This example was prepared to demonstrate the ability to produce a low temperature soy based powder resin that retains the properties of the “preferred adhesive state”. The resin contains only soy flour, water and denaturant (sodium hydroxide) with no cross-linking agent or additives.

TABLE 1

| Sequence | Ingredient | Amount (g) | % to Soy |
|---|---|---|---|
| 01 | Water | 154.3 | |
| 02 | Soy Flour | 48.2 | |
| 03 | 50% NaOH | 9.6 | 10.0 |
| Total | | 212.1 | |

The preparation is a three-stage process as outlined below.

Stage I: To a 500 mL flask equipped with mechanical stirring, water was charged followed by the addition of soy flour at room temperature to form a semi-soluble solution/dispersion. The mixture was allowed to stir for 5 minutes to ensure homogeneity, after which the denaturant, sodium hydroxide, was charged drop-wise over 1-2 minutes to the rapidly stirring mixture. The mixture was allowed to stir at room temperature for 10 minutes. The viscosity of the adhesive quickly increased to afford a creamy, light brown adhesive mixture containing the soy in the “preferred adhesive state.”

Stage II: Addition of cross-linking agent: No cross-linking agent was added to this example

Stage III: Conversion to powder: A portion of the aqueous adhesive mixture made in Stage I, was then converted to a powdered adhesive by lyophilization, while the remainder was used to evaluate the viscosity stability of the aqueous resin mixture prepared in Stage I. 85.2 g of the mixture from Example 1 Stage I was placed inside a 600 mL LABCONCO™ lyophilization flask. The flask was then placed inside a freezer at −70° C. for a period of no less than 30 minutes to ensure a full freeze of the material. The frozen sample was then placed on the LABCONCO™ lyophilizer for a period of 24 hours under a vacuum of 5-10 microns Hg. The cooling coils were at −40° C. After the 24-hour period, the sample was removed from the lyophilizer, ground with a mortar and pestle and passed through a 65 mesh screen. The resultant powder was a light brown hard material.

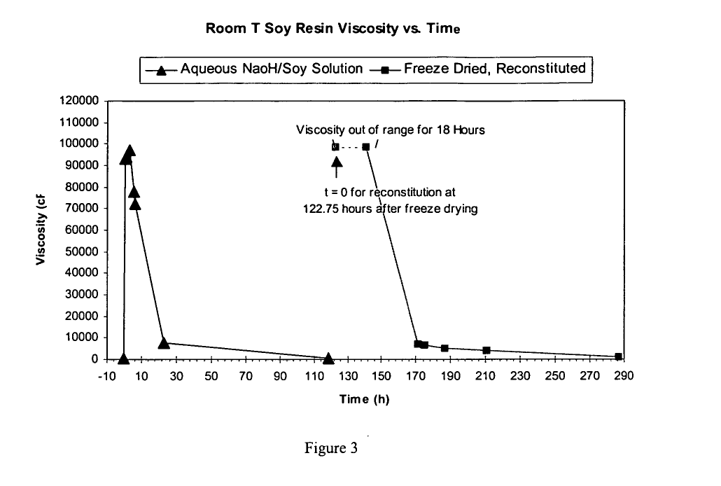

A comparison of the viscosity stability of the aqueous mixture (Stage I) over time at room temperature is compared with the initial viscosity and stability of reconstituted Stage III material. This data is shown in FIG. 3.

The results from FIG. 3 demonstrate that the “preferred adhesive state” can be preserved by converting the liquid adhesive from Stage I into a powder form. This allows for the adhesive to be stored for extended periods of time and to be used as either a powder resin or reconstituted to an aqueous mixture.

### Example 2

A reactive phenol-formaldehyde was prepared by combining components in the order as listed in Table 2. The reactive resin was later blended with a denatured soy flour mixture as shown in examples 3-5.

TABLE 2

| Sequence | Ingredient | Amount (g) | Moles to Phenol |
|---|---|---|---|
| 01 | Phenol 100% | 450.0 | 1.00 |
| 02 | Formaldehyde 37% | 805.5 | 2.08 |
| 03 | NaOH 100% | 53.6 | 0.14 |
| 04 | NaOH 100% | 24.1 | 0.06 |
| | Total | 1333.2 | |

All of the phenol (1) and formaldehyde (2) where combined in a 2 L flask at room temperature. The solution was heated to 25° C. when 50% NaOH (3) was added drop-wise. The solution was then heated to 69-71 ° C. over 15 minutes using cooling to prevent over-heating and held for 1.0 hour. The remainder of the 50% NaOH (4) was then added drop-wise to the solution, while maintaining a temperature of 69-71° C. The solution was then heated to 84-86° C. over 15 minutes and held for an anticipated Gardner viscosity of “O-P”. The solution was cooled to 40° C. in a cold water bath over 10-15 minutes, filtered through a coarse screen and stored in the refrigerator for later use.

### Example 3

To improve the durability, mainly the water resistance of the powder adhesive from Example 1, some phenol formaldehyde cross-linking agent, as prepared from example 2, was added to a Stage I resin similar to example 1.

TABLE 3

| | | | |
|---|---|---|---|
| Sequence | Ingredient | Amount (g) | % to Soy |

Stage I

| | | | |
|---|---|---|---|
| 01 | Water | 214.3 | |
| 02 | Soy Flour | 48.2 | |
| 03 | 50% NaOH | 33.8 | 35.1 |

Stage II

| | | | |
|---|---|---|---|
| 04 | Phenol Formaldehyde | 116.2 | 54.1 |
| | Example 2 | | |
| | Total | 412.5 | |

Stage I: To a 1000 mL flask equipped with mechanical stirring, water was charged followed by the addition of soy flour at room temperature to form a semi-soluble solution/dispersion. The mixture was allowed to stir for 5 minutes to ensure homogeneity, after which the denaturant, sodium hydroxide, was charged drop-wise over 1-2 minutes to the rapidly stirring mixture. The mixture was allowed to stir at room temperature for 10 minutes. The viscosity of the adhesive quickly increased to afford a creamy, light brown adhesive mixture containing the soy in the “preferred adhesive state.”

Stage II: To the stirring mixture was added a phenol-formaldehyde (PF) resin, such that the final ratio of soy/PF on a solids basis was approximately 50/50. The mixture was allowed to stir at room temperature for 10 minutes. The viscosity of the mixture decreased slightly and yielded a creamy, dark brown mixture.

Stage III: Conversion to powder: The aqueous adhesive mixture made in Step II, was then converted to a powdered adhesive by lyophilization. 100.0 g of the mixture from Example II Step II was placed inside a 600 mL LABCONCO™ lyophilization flask. The flask was then placed inside a freezer at −70° C. for a period of no less than 30 minutes to ensure a full freeze of the material. The frozen sample was then placed on the LABCONCO™ lyophilizer for a period of 24 hours under a vacuum of 5-10 microns Hg. The cooling coils were at −40° C. After the 24-hour period, the sample was removed from the lyophilizer, ground with a mortar and pestle and passed through a 65 mesh screen. 28.8 g of powdered material was recovered. The resultant powder was a brown, hard material.

The powder was evaluated for curing using a Differential Scanning Calorimeter (DSC4-Perkin-Elmer) in stainless sealed cells from 40-200C with a heat-up rate of 10° C./min. Due to the absence of any flow additives and/or plasticizers, the thermogram showed no occurrence of any thermal transition from the curing mechanisms. However, when used as a powder adhesive, sufficient flow was achieved to develop good bonding due to the water in the wood serving to enhance the flow/penetration of the powder adhesive into the wood substrate.

### Example 4

To enhance the ability of the powder adhesive to flow and provide better end-use performance, polyethylene glycol MW:300 (referred to as PEG MW300 hereafter) was added prior to the Stage III powder development.

A resin was prepared by combining components in the order as listed in Table 4.

TABLE 4

| | | | |
|---|---|---|---|
| Sequence | Ingredient | Amount (g) | % to Soy |

Stage I

| | | | |
|---|---|---|---|
| 01 | Water | 107.2 | |
| 02 | Soy Flour | 24.1 | |
| 03 | 50% NaOH | 14.3 | 29.7 |

Stage II

| | | | |
|---|---|---|---|
| 04 | Phenol Fomaldehyde | 57.2 | 53.7 |
| | Example 2 | | |
| 05 | Polyethylene Glycol | 2.41 | 10.0 |
| | MW = 300 g/mole | | |
| | Total | 205.2 | |

Stage I: To a 500 mL flask equipped with mechanical stirring, water was charged followed by the addition of soy flour at room temperature to form a semi-soluble solution/dispersion. The mixture was allowed to stir for 5 minutes to ensure homogeneity, after which the denaturant, sodium hydroxide; was charged drop-wise over 1-2 minutes to the rapidly stirring mixture. The mixture was allowed to stir at room temperature for 10 minutes. The viscosity of the adhesive quickly increased to afford a creamy, light brown adhesive mixture containing the soy in the “preferred adhesive state.”

Stage II To the stirring mixture was added a PF resin such that the final ratio of soy/PF on a solids basis was approximately 50/50. The mixture was allowed to stir at room temperature for 10 minutes. The viscosity of the mixture decreased slightly and yielded a creamy, dark brown mixture. To the stirring mixture was added PEG MW300 such that the ratio of soy/PEG MW300 was 1/0.1 w/w. The mixture was allowed to stir at room temperature for 5 minutes. There was no noticeable change in viscosity or color upon addition of the PEG MW300.

Stage III: Conversion to powder: The aqueous adhesive mixture made in Step II, was then converted to a powdered adhesive by lyophilization. 103.9 g of the mixture from Example II Step II was placed inside a 600 mL LABCONCO™ lyophilization flask. The flask was then placed inside a freezer at −70° C. for a period of no less than 30 minutes to ensure a full freeze of the material. The frozen sample was then placed on the LABCONCO™ lyophilizer for a period of 24 hours under a vacuum of 5-10 microns Hg. The cooling coils were at −40° C. After the 24-hour period, the sample was removed from the lyophilizer, ground with a mortar and pestle and passed through a 65 mesh screen. 30.3 g of powdered material was recovered that appeared identical to the powder obtained in Example 3.

The powder was evaluated for curing using a Differential Scanning Calorimeter (DSC4-Perkin-Elmer) in stainless sealed cells from 40-200° C. with a heat-up rate of 10° C./min. Due to the presence of the plasticizer, PEG MW300, the thermogram clearly showed the thermal transition from the curing typically observed with thermosetting phenol-formaldehyde resins. Clearly, the addition of the poly(ethylene glycol) aided the ability of the resin to flow and develop the necessary cross-linking reactions.

### Example 5

A higher soy containing form of Example 4 was prepared. The sample with a 75/25 soy/PF ratio and a 1/0.1 soy/PEG MW300 ratio was prepared by combining components in the order as listed in Table 5.

TABLE 5

| | | | |
|---|---|---|---|
| Sequence | Ingredient | Amount (g) | % to Soy |

Stage I

| | | | |
|---|---|---|---|
| 01 | Water | 237.9 | |
| 02 | Soy Flour | 48.2 | |
| 03 | 50% NaOH | 12.2 | 12.7 |

Stage II

| | | | |
|---|---|---|---|
| 04 | Phenol Formaldehyde | 30.5 | 23.6 |
| | Example 2 | | |
| 05 | Polyethylene Glycol | 4.8 | 10.0 |
| | MW = 300 g/mole | | |
| | Total | 333.6 | |

Stage I: To a 500 mL flask equipped with mechanical stirring, water was charged followed by the addition of soy flour at room temperature to form a semi-soluble solution/dispersion. The mixture was allowed to stir for 5 minutes to ensure homogeneity, after which the denaturant, sodium hydroxide, was charged drop-wise over 1-2 minutes to the rapidly stirring mixture. The mixture was allowed to stir at room temperature for 10 minutes. The viscosity of the adhesive quickly increased to afford a creamy, light brown adhesive mixture containing the soy in the “preferred adhesive state.”

Stage II: To the stirring mixture was added a PF resin such that the final ratio of soy/PF on a solids basis was approximately 75/25. The mixture was allowed to stir at room temperature for 10 minutes. The viscosity of the mixture increased slightly and yielded a creamy, light brown mixture. To the stirring mixture was added PEG MW300 such that the ratio of soy/PEG MW300 was 1/0.1 w/w. The mixture was allowed to stir at room temperature for 5 minutes. There was no noticeable change in viscosity or color upon addition of the PEG MW300.

Stage III: Conversion to powder: The aqueous adhesive mixture made in Step II, was then converted to a powdered adhesive by lyophilization. 137.6 g of the mixture from Example II Step II was placed inside a 600 mL LABCONCO™ lyophilization flask. The flask was then placed inside a freezer at −70° C. for a period of no less than 30 minutes to ensure a full freeze of the material. The frozen sample was then placed on the LABCONCO™ lyophilizer for a period of 24 hours under a vacuum of 5-10 microns Hg. The cooling coils were at −40° C. After the 24-hour period, the sample was removed from the lyophilizer, ground with a mortar and pestle and passed through a 65 mesh screen. 29.5 g of powered material was recovered. The resultant powder was a light brown, hard material.

A summary of the properties and results obtained with these examples can be found in Table 7.

### Example 6

A soy using a formaldehyde free cross linking agent was prepared as follows.

TABLE 6

| | | | |
|---|---|---|---|
| Sequence | Ingredient | Amount (g) | % to Soy |

Stage I

| | | | |
|---|---|---|---|
| 01 | Water | 125.0 | |
| 02 | Soy Flour | 33.3 | |
| 03 | 50% NaOH | 0.4 | 0.60 |

Stage II

| | | | |
|---|---|---|---|
| 04 | Maleic Anhydride | 1.7 | 23.6 |
| 05 | 50% NaOH | 2.7 | 4.05 |
| 06 | Linseed Oil | 1.7 | 10.0 |
| 07 | 50% NaOH | 2.4 | 3.60 |
| | Total | 166.9 | |

Stage I: To a 500 mL flask equipped with mechanical stirring, water was charged followed by the addition of soy flour at room temperature to form a semi-soluble solution/dispersion. The mixture was allowed to stir for 5 minutes to ensure homogeneity, after which the denaturant, sodium hydroxide (03), was charged drop-wise over 1-2 minutes to the rapidly stirring mixture.

Stage II: To the stirring mixture, maleic anhydride was added along with the additional NaOH (06) to keep the pH between 7-9. The mixture was allowed to stir at room temperature for 20 minutes. The linseed oil was then added followed by additional NaOH (07) and allowed to stir at room temperature for 10 minutes.

Stage III: Conversion to powder: The aqueous adhesive mixture made in Step II, was then converted to a powdered adhesive by lyophilization. Approximately 100.0 g of the mixture from Example II Step II was placed inside a 600 mL LABCONCO™ lyophilization flask. The flask was then placed inside a freezer at −70° C. for a period of no less than 30 minutes to ensure a full freeze of the material. The frozen sample was then placed on the LABCONCO™ lyophilizer for a period of 24 hours under a vacuum of 5-10 microns Hg. The cooling coils were at −40° C. After the 24-period, the sample was removed from the lyophilizer, ground with a mortar and pestle and passed through a 65 mesh screen.

* a 25 sample of example 2 was freeze dried in a manner similar to that employed for examples 1, 3, 4, and 5.

### Example 7

To evaluate the ability of the powder adhesive to bond wood, a 2 ply panel using 7″×7″ southern yellow pine veneers were prepared using 2.0 g of the powder adhesive made in Example 1. The veneers were conditioned in a 80° F./30% humidity room for several weeks prior to being used. The panel was pressed in a lab press at 200° C. for a period of 5 minutes with a load of 10,000 lbs. The final panel showed no delamination upon removal from the press. The 2-ply was cut into 4 equal sections. Two sections were conditioned by boiling for 2 hours, while the other 2 were kept dry. The delamination of the boiled samples was noted and is shown in Table 8. The sections were manually pulled apart and the % wood failure was estimated.

### Example 8

A two ply panel was prepared from 2.0 g of the powder adhesive prepared from Example 2 in a similar manner as shown in Example 7. The results are shown in Table 8.

### Example 9

A two ply panel was prepared from 2.0 g of the powder adhesive prepared from Example 3 in a similar manner as shown in Example 7. The results are shown in Table 8.

### Example 10

A two ply panel was prepared from 2.0 g of the powder adhesive prepared from Example 4 in a similar manner as shown in Example 7. The results are shown in Table 8.

### Example 11

A two ply panel was prepared from 2.0 g of the powder adhesive prepared from Example 5 in a similar manner as shown in Example 7. The results are shown in Table 8.

The DSC results suggest that the addition of the flow agent (PEG) is important in obtaining the proper flow of the powder resin to facilitate the desired cross-linking copolymerization reactions.

TABLE 8

| | | Dry Conditions | | 2 Hour Boil* | |
|---|---|---|---|---|---|
| 2-Ply | Resin | % De- | % Wood | % Delami- | % Wood |
| Example | Example | lamination | Failure | nation | Failure |
| 7 | 1 | 0 | 12.5 | 100 | N/A |
| 8 | 2 | 0 | 80 | 0 | 85 |
| 9 | 3 | 0 | 95 | 0 | 30 |
| 10 | 4 | 0 | 85 | 0 | 10 |
| 11 | 5 | 0 | 10 | 0 | 5 |

*Samples were air-dried at room temperature for 30 minutes prior to evaluation

The results in Table 8 clearly show the ability of the powder soy adhesive to provide excellent dry panel performance even without the addition of a cross-linking agent. That is, all of the panels showed 0% delamination. The water resistance was assessed by subjecting the 2 plys to a rigorous 2 hour boil. Of much interest, was the fact that both the 1/1 and the 1/3 PF/Soy powder resins produced panels with 0% delamination even after exposure to such extreme conditions.

### Example 12

To evaluate the powder adhesive's ability to bond to wood flour, most notably, for molded product type applications, 5.0 g of wood flour was combined with 1.0 g of the powder adhesive from Example 4. The two powders were blended by placing both of them into a sealed jar and manually shaking the jar for several minutes. The resultant powder appeared to be homogeneous. 6.0 g of the wood flour/powder adhesive blend were placed on a caul plate and with minimal spreading to simulate a molded product application. The press temperature was 200° C., and was closed rapidly using 10,000 lbs and held for 5 minutes. The fused wood product that resulted was very hard and strong. After boiling the sample in water for 2 hours, there was no apparent softening of the sample. In fact, the boiled sample was so hard that the surface was unable to be scratched using a scraping motion with a screwdriver or nail.

We claim:

1. A method of preparing a protein-based adhesive, the method comprising the steps of:
denaturing a protein, whereby a denatured protein in an adhesive state is obtained; and
drying the protein, wherein the protein is in a powder form.

2. The method of claim 1, further comprising the step of:
cross-linking the denatured protein with a cross-linking agent to yield a cross-linked product, wherein the agent is selected from the group consisting of phenol formaldehyde, urea formaldehyde, melamine formaldehyde, melamine urea formaldehyde, resorcinol formaldehyde and/or formaldehyde free agents such as polyamidoamine epichlorohydrin (PAE), glyoxal, and other water soluble aldhehydes, linseed oil, tung oil and mixtures thereof.

3. The method of claim 1, wherein the protein comprises a soy protein.

4. The method of claim 3, wherein the soy protein comprises soy flour protein.

5. The method of claim 4, wherein the soy flour has a particle size of 80 mesh or less.

6. The method of claim 4, wherein the soy flour comprises from 0 wt. % to 12 wt. % of a soy bean oil.

7. The method of claim 4, wherein the soy flour comprises from 30 wt. % to 100 wt. % of a protein.

8. The method of claim 1, wherein the protein comprises soy isolate.

9. The method of claim 1, wherein denaturing is conducted in the presence of an alkali.

10. The method of claim 9, wherein the alkali comprises sodium hydroxide or potassium hydroxide.

11. The method of claim 1, wherein the step of denaturing comprises the steps of:
forming an aqueous, alkaline mixture of the protein; and
maintaining the mixture, whereby a denatured protein is obtained.

12. The method of claim 11, wherein the mixture comprises from 6 wt. % to 20 wt. % sodium hydroxide.

13. The method of claim 1, wherein denaturing is conducted for 1 hour or less and at a temperature of from 20° C. to 90° C.

14. The method of claim 2, wherein the cross-linking agent comprises phenol formaldehyde.

15. The method of claim 1, wherein the adhesive comprises from 5 wt. % to 95 wt. % of the cross-linking agent.

16. The method of claim 15, wherein the adhesive comprises between 30% - 60% cross-linking agent.

17. The method of claim 1, further comprising the steps of:
preparing a cross-linking agent; and
blending the cross-linking agent with the protein to denature in situ.

18. The method of claim 1, further comprising the step of:
blending additional cross-linking agents into the denatured protein.

19. The method of claim 1, wherein the adhesive has a pH of from I to 13.5.

20. The method of claim 1, further comprising the step of:
adding a component selected from the group consisting of extenders, fillers, accelerators, catalysts, water, and mixtures thereof to the adhesive.

21. The method of claim 1, further comprising the steps of:
providing a solid substance;
contacting the solid substance with the dried adhesive; and
recovering a composite.

22. The method of claim 21, wherein the composite comprises a fiberboard.

23. The method of claim 21, wherein the solid substance comprises an agricultural material.

24. The method of claim 22, wherein the agricultural material is selected from the group consisting of corn stalk fiber, poplar fiber, wood chips, wood flakes, wood particles, wood fibers, wood boards, wood veneer, and straw.

25. A powder adhesive of denatured soy protein.

26. The adhesive of claim 25, wherein the powder adhesive is combined with a cross-linking agent.

27. The adhesive of claim 25, wherein the soy protein comprises soy isolate.

28. The adhesive of claim 25, wherein the soy protein comprises soy meal having a protein content of from 40 wt. % to 50 wt. % and an oil content of less than 11 wt. %.

29. The adhesive of claim 26, wherein the cross-linking agent is a methylol compound selected from the group consisting of dimethylol phenol, dimethylol urea, tetranethylol ketone, and trimethylol melamine.

30. The adhesive of claim 26, wherein the cross-linking agent comprises a co-reacting pre-polymer.

31. The adhesive of claim 30, wherein the co-reacting pre-polymer comprises phenol formaldehyde.

32. The adhesive of claim 30, wherein the co-reacting prepolymer comprises phenol formaldehyde, and wherein the adhesive comprises less than 2.5 wt. % free phenol and less than 1 wt. % free formaldehyde.

33. A composite board comprising a powder adhesive of denatured soy protein and a solid material.

34. The composite board according to claim 33, wherein the solid material is selected from the group consisting of wood chips, wood fiber, wood flakes, wood board, wood veneer, and wood particles, corn stalk fiber, poplar fiber, and straw.

35. The composite board of claim 33, further comprising a wax.
